(19) United States
(12) Patent Application Publication
(10) Pub. No.: US 2004/0098868 A1
(43) Pub. Date: May 27, 2004

(54) Finger supported food cutting surface

(76) Inventor: Paul S. Pieper, Petersburg, AK (US)

Correspondence Address: Paul S. Pieper, P O Box 836, Petersburg, AK, 99833, US

(21) Appl. No.: 10/313,673

(22) Filed: Nov. 27, 2002

(51) Int. Cl. B26B 27/00

(52) U.S. Cl. 30/298

(57) ABSTRACT

A device for protecting the index finger of the hand opposite the cutting hand when cutting comestible. It is tapering, approximately cylindrical and of flexible thermoplastic, with an optional extension to cover the third joint. The extension can have a hole for convenient storage on a hook. The device is designed to accommodate various finger sizes and can be further reduced in diameter to fit the smallest fingers by slipping an optional narrow sleeve over the cylindrical shaft.

### CROSS REFERENCE TO RELATED APPLICATIONS

(Not Applicable)

### STATEMENT OF FEDERALLY SPONSORED RESEARCH/DEVELOPMENT

(Not Applicable)

### REFERENCE TO A “SEQUENCE LISTING”

(Not Applicable)

### BACKGROUND OF THE INVENTION

The forenamed device would come under the International Classification of Goods and Services in paragraph #21 as household or kitchen utensils.

It is well known that in the food processing art, certain foods are cut or chopped on boards of wood or plastic or some food in small amounts is cut or sliced against the index finger. The latter quick method can result in small cuts on that digit. The cutting board, because of size, can lack convenience as to storage, access and cleaning. The present invention is designed to provide a food cutting surface on an easily detachable covering of the index finger. A protective covering for part of the finger to the first joint is offered in the sewing art in the form of a thimble. That device is ordinarily short and closed on the end. While it could be of plastic, it is often of metal and meant to protect the finger from needle pricks. This inventor has heard of a patent application for protection of the fingers from scissor cuts in the hair styling field. But both of those occupations would require certain dexterity of the various joints of the fingers; whereas it is advantageous if the present device in cutting surface remains ridged to the knuckle and covers all or most of the length of the index finger with a blade preserving material deemed non-toxic in water. Also devices with closed distal tips and complete enclosure of the finger without a surface break with or without overlap don't have the advantage of variation for various finger sizes.

Another device used for cutting comestible that the applicant has seen advertised is specifically a knuckle protector when cutting on a chopping board, but in that use the four fingers are flexed into a fist. That device isn't integral to the cutting surface as are possible examples of the present device the user has the disadvantage of having to store both the cutting surface and knuckle (fist) protector. That combination also is not readily adaptable to cutting over the container of use.

### BRIEF SUMMARY OF THE INVENTION

This device in food cutting surface is designed to cover and closely conform to the index finger on the hand opposite the hand customarily holding the knife. It is roughly circular in cross section, open on both ends and preferentially has an extension tension to cover the third joint of the finger. Therefore the primary object of the invention is to protect the forementioned finger from cuts when processing foodstuffs.

Another object of the invention is to facilitate rapid, convenient cutting and dicing of small amounts of foodstuffs.

Another object of the invention is convenience of storage because of its small size, a hole in the knuckle extension to accommodate a wall hook; or the device's adaptability to a wall peg.

A further object of the invention is ease of cleaning.

Another object of the invention is to have a device that is comfortable to use and convenient of removal by variation of size configuration by flexibility of material.

And another object of the invention is that foodstuffs can be cut directly over the container of use.

Another object of the invention is low cost of material and manufacture.

A further object of the invention is that a thin, narrow, detachable sleeve can be slipped over the device to further diminish the size of the flexible configuration for use by people with smaller fingers.

### BRIEF DESCRIPTION OF THE SEVERAL VIEWS OF THE DRAWING

#10 is the Finger Supported Food Cutting Surface.

FIG. 1 is the device from a view of the underside.

FIG. 2 is a side view of the device.

FIG. 3 is a cross section from 1--1 of FIG. 2.

FIG. 4 is the end view or the detachable securing sleeve.

FIG. 5 is a side view of the securing sleeve. 14 of FIG. 1 is the hole for detachably securing the device on a storage hook.

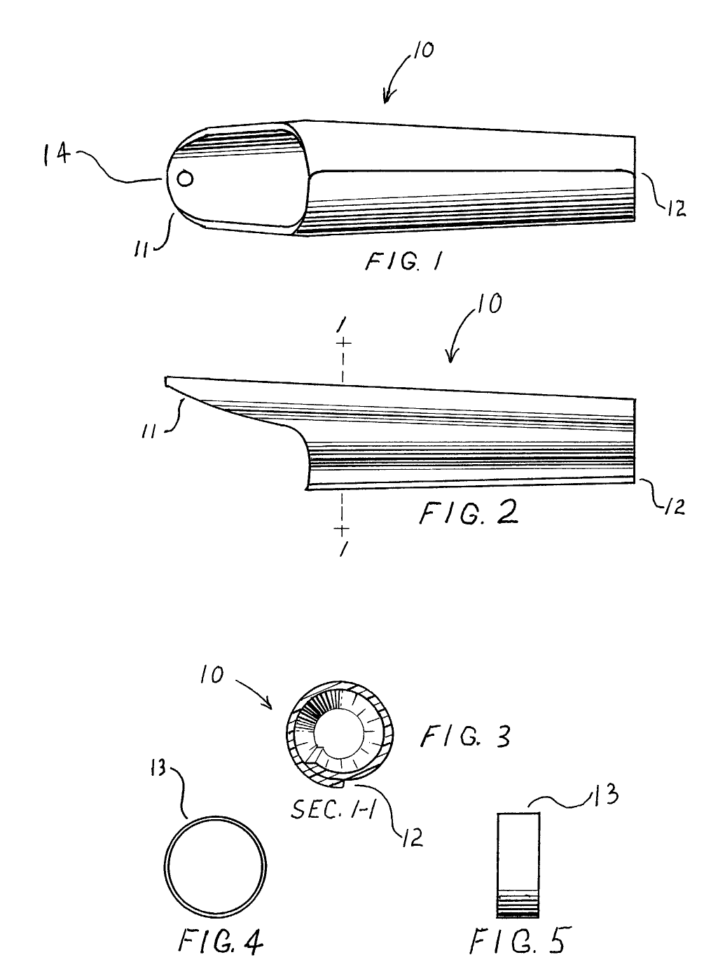

### DETAILED DESCRIPTION OF THE INVENTION

One of the early concepts of the invention was a simple, slightly tapering cylinder machined from a polypropylene (PP) pipe fitting. In that configuration it was found to be quite useful but it was recognized that the device would be rather limited as to finger size and various sizes would have to be produced. Thermoplastic billets also were machined to the desired shape, with the addition of an extension over the top surface of the finger to cover the third joint of the index finger but that concept, because of thickness of the thermoplastic would also require various sizes.

To give some flexibility for variation of fit a configuration of the device was cut from a tapering, slightly curved, polyethylene nozzle of a fuel jug (Igloo Corp. Houston, Tex. 77024, Mod. #2057). The knuckle extension was included and a slit cut along the bottom to the open small end which would give a certain amount of flexible play in the approximately 2 mm thick material. The nozzle appears to have been blow molded. It is possible that such tapering nozzles could be purchased preformed. As tooling up for blow molding such precursor for the device would be prohibitively expensive without market justification a cheaper method from the known prior art using a mandrel or core with a two part mold of traditional mold materials (e.g. plaster or high temperature epoxy) was developed, but it was subsequently found that a much faster method of making molds was to spot weld high density polyethylene (HDPE) of 1 mm to 1.5 mm. in thickness, up to 18 cm. in width and up to 15 cm. for wrapped length around a model of the device. It is best if the inside edge is thinned (chamfered). Spot welding the edges can be done with a fine tipped soldering iron while holding the wrap, briefly, with elastomer “O” rings.

In to this tapering, smooth mold a preformed precursor of the device and the mandrel of wood, epoxy or HDPE can be firmly inserted. Preforming is completed by using four or more high temperature elastomer “O” rings to hold the rolled up approximate shape, which is held briefly in boiling (100 c.) water and the “O” rings removed.

Using HDPE or PP of thickness from 0.5 mm. to 1.5 mm. to make one of various possible concepts of the precursor flat pattern of the present device in cutting surface: starting at the center from a horizontal line 6.2 cm. long a vertical line is drawn to a point at 12 cm. Three cm. of the distal end of the vertical line and 1.5 cm. each way from the vertical line defines the knuckle protecting extension except for the curve at the end which is of optional curvature. From point 2.8 cm. each way from the base of the knuckle protecting extension lines are drawn to the respective ends or the primary horizontal line. The configurations of the curves at the corners are optional.

While the flat precursor has been cut with scissors so far, obviously mechanized means of stamping out the flat shape would be much more efficient though intially expensive to tool up for.

After inserting the product of premolding and a mandrel into the mold the combination is placed in an autoclave or pressure cooker with water and the temperature brought up to 120° --124° C. Both 1 mm. thick HDPE and PP hold form well at that temperature range and don't seem to be degraded after being held at that range briefly.

To give greater range of finger size for the device the mandrel, the mold and the pattern were sized to result in an overlap on the underside. That can be from zero overlap, as a simple cut along the length to as much to as much as 3.2 cm. of overlap. The distal small end is left open for flexibility and cleaning.

For particularly small fingers and for greater security a thin thermoplastic band or sleeve can be slipped over the unit. Bands 1 to 1.5 cm. width have been cut from empty salve tubes giving about 2.5 cm. in expanded diameter with about 0.2 or 0.3 mm. in wall thickness. To better maintain the sleeve detachably secure a thin coat of rubber cement was dried on the inside surface. For smaller sizes such tubing bands could be cut to permit a welded overlap to give still less diameter. Salve tubing of this sort could no doubt be obtained without logo or other markings from wholesalers of such tubes.

The device has also been formed from common black HDPE 2.5 cm. water pipe by cutting a wedge from the bottom to accomplish the preferred taper, then the edges chamfered and the unit molded to overlap on the side opposite the cutting surface, That pipe is about 2 mm. in thickness. At that thickness the flexibility is diminished and various sizes of the device might have to be made to accommodate various finger sizes. It occurs to this inventor that such stout finger protection might be useful in various industrial environments.

If, as previously suggested, market demand for the device warrented blow molding the precurser tapering tube would be an options. In the prior art this has been accomplished by extruding a thermoplastic (e.g. HDPE or PP pipe into a two part mold and by means of steam or compressed air the thermoplastic is made to conform to the walls of the mold. The walls of the polymer pipe would have to be slightly thicker than the desired wall thickness of the finished blown product would then have to be cut lengthwise, cut off at the small end, the knuckle protecting extension formed and the optional hole punched in that.

Another polymer that could be used for blow molding the tapering tube precurer is poly(ethylene terethalate).

It has been observed that certain of the tubular thermoplastic polymers will spontaneously overlap when slit longitudinally. As it seems that the tendency is the result of molecular stresses induced on cooling it would be advantageous to use materials that have such transition in extrusion and blow molding to increase the tendency even in the thinner materials found to be important in producing an ergenomically suitable product.

It isn't the intention of the applicant to restrict the thermoplastics to those mentioned in the specifications. There others with similar physical characteristics that could find application in the fabrication of the device. And as the molding of he device can be accomplished at temperatures from 100° C. to 255° C. it isn't the intention to restrict to any temperature need it be restricted to a water or steam environment.

Recognising that chopping or cutting boards are well known in the prior food processing art and even fist protection can be worn to protect from accidents during such chopping, wherein the improvement comprised of the following as what I claim as new and improved is:

1. The device a finger supported, finger enclosing food cutting surface.
Said device cut longitudinally at the side opposite the cutting surface and/or premolded to have an overlap of optionally from 0 to as much as 2.3 cm.
Said cutting surface comprised of thermoplastic of thinness as to permit such flexibility as to allow easy access to and egress from by the index finger.

2. The claim according to claim No. 1 whereby the cutting surface has an integral extension to cover the third joint of the said index finger.
Said extension having near its end an optional hole to accommodate a storage hook.

3. A thin thermoplastic band to further reduce the diameter of the finger supported, finger enclosing surface for particularly small fingers that can be be slipped over the device.
